(19) United States
(12) Patent Application Publication
(10) Pub. No.: US 2002/0129720 A1
(43) Pub. Date: Sep. 19, 2002

(54) Changing station for printing machines

(76) Inventors: Rainer Jendroska, Greven (DE); Alois Thoele, Lienen (DE)

Correspondence Address: JACOBSON HOLMAN PLLC, 400 SEVENTH STREET N.W., SUITE 600, WASHINGTON, DC, 20004, US

(21) Appl. No.: 10/097,856

(22) Filed: Mar. 15, 2002

(30) Foreign Application Priority Data
Mar. 15, 2001 (DE) 101 12 522.4

(51) Int. Cl. B41F 5/00

(52) U.S. Cl. 101/216

(57) ABSTRACT

The invention relates to a changing station for sleeves of printing machines with a lifting platform, disposed on the side of the printing machine, and with a wagon, in which a vertically adjustable shelf with carrying mandrels for receiving sleeves is received, whereby the shelf can be coupled to the lifting platform for joint lifting and lowering.

The invention relates to a changing station for sleeves of printing machines.

The operation of printing machines requires that the printing sleeves or engraved roller sleeves have to be changed. In the case of larger printing machines the printing sleeves can exhibit a weight of approximately 20 kg. The operating personnel must change these printing sleeves manually, whereby the respective sleeve mandrel inside the printing machine can be reached only by means of a ladder. Thus, such a changing of the sleeves is troublesome for the operating personnel and subject to accidents.

The object of the present invention is to provide a changing station for sleeves that makes it easier for the operating personnel to change the sleeves in printing machines.

The invention solves this problem by a combination of features, according to claim 1. Thus, there is a changing station for sleeves of printing machines, in which a lifting platform, on which the operating personnel stands for the purpose of changing the sleeves, is provided at the side of the printing machine.

Furthermore, a wagon is a component of the changing station, in which a vertically adjustable shelf with carrying mandrels for receiving the sleeves is accommodated, whereby the shelf can be coupled to the lifting platform for joint lifting and lowering.

This changing station gives the operating personnel the possibility of handling in a safe and simple manner the sleeves in a plane between the printing machine and the shelf, which exhibits carrying mandrels and is disposed in the same plane. It is especially advantageous that all sleeves can be received immediately in the changing station so that there is no need to climb the ladder with great effort after depositing each sleeve. The changing station makes it possible to change the sleeves much faster and with greater ease and without danger.

Especially advantageous designs of the changing station, according to the invention, are disclosed in the dependent claims following the main claim.

It follows that the lifting platform can exhibit a front and two side protective gates, whereby at least one of the side protective gates is designed as a folding door. Thus, the safety requirements for the operating personnel are met.

The lifting platform can be raised and lowered advantageously by means of a motor-driven scissor lift.

The wagon is enclosed advantageously on three sides and open in the direction of one side, whereby the shelf receiving the carrying mandrels is oriented in such a manner in the wagon that the carrying mandrels can be attended from the open side of the wagon. The wagon can be open at the top; and the vertically adjustable shelf can be mounted in the wagon so as to be vertically adjustable by means of slide bearings.

Finally the shelf can be made of a structural steel beam, whereby this structural steel beam can be coupled to the front protective gate of the lifting platform by means of a coupling mechanism. The coupling mechanism comprises advantageously journals, which engage with an opposing journal receptacle.

It is also advantageous to dispose on the front protective gate of the lifting platform additionally support brackets, against which at least one support of the shelf is braced in the coupled state.

The wagon can be mounted, according to a preferred design variant, on rollers, which can be locked by means of locking brakes.

Other details and advantages of the invention are explained in detail with reference to the embodiment depicted in the drawings.

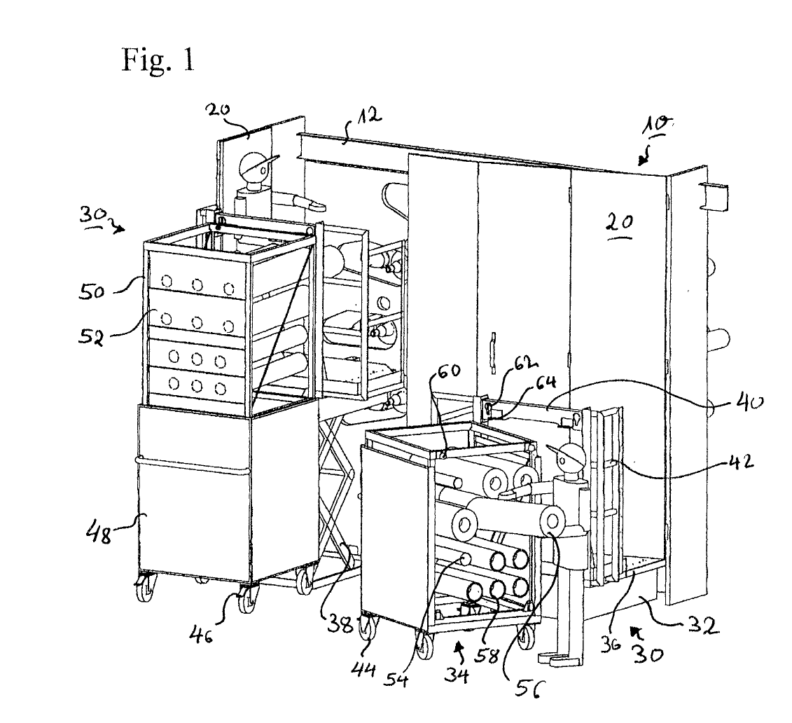

FIG. 1 is a perspective view of the inventive changing station in different working positions; and

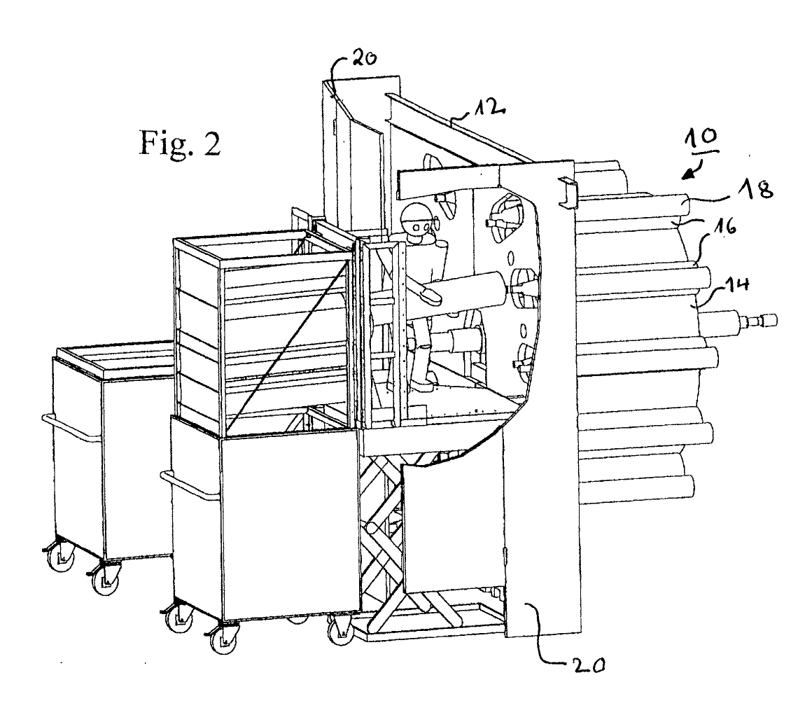

FIG. 2 is a perspective view of the changing station, according to FIG. 1, at a different viewing angle and in a different working position of the respectively illustrated changing stations.

In FIG. 2 the reference numeral 10 refers to a part of a printing machine, whereby a row of printing rollers 16 or engraved rollers 18 are disposed in the known manner around a counter pressure cylinder 14 in a support frame 12, which is only partially shown here. The printing machine can be closed by means of folding doors 20 on the side, whereby the drawings, according to FIG. 2 and/or FIG. 1, show the folding doors in different folding positions.

FIGS. 1 and 2 show two changing stations 30 in different positions next to the printing machine. The changing stations comprise in essence a lifting platform 32 and a wagon 34.

The lifting platform 32 exhibits a floor 36, which can be moved by means of a scissor lift 38. The scissor lift 38 is moved by means of a motor, which is not shown in detail here. On the floor 36 is a front protective gate 40 and two side protective gates 42, both of which can be folded open.

The wagon 34 can be driven on rollers 44, whereby the rollers 44 exhibit locking brakes 46, which are foot operated so as to lock the rollers 44. The wagon exhibits walls 48 on three sides. Inside the walls is a shelf 50, which is made of a welded structural steel beam and can be vertically adjusted by means of slide bearings, which are not shown in detail here. The rear side 52 of the shelf has a total of 12 mandrels 54 so that, as shown in FIG. 1, they are accessible to the operating personnel from the open side of the wagon 34. FIG. 1 shows in the right wagon 34 how a printing sleeve 56 is being removed. Below the printing sleeves the engraved roller sleeves 58 are slid onto the mandrels 54.

The wagon 34 can be coupled to the lifting platform 30 so that the shelf 50 can be raised and lowered together with the lifting platform. The coupling is effected by means of two journals 60, which are disposed at the uppermost support of the shelf 50 and which can be inserted into journal receptacles 62 at the front protective gate 40 of the lifting platform 30. Finally there are on the front protective gate 40 two support brackets, which support from below the corresponding support of the shelf after the journals 60 have been coupled into the journal receptacle 62.

Thus, as the lifting platform 30 is raised and lowered, so can the shelf 50 of the wagon 34 be simultaneously raised and lowered.

FIG. 1 shows on the right hand side how a printing sleeve 56 is being removed. Here the wagon 34 is uncoupled from the lifting platform 30, and the shelf 50 is moved into the wagon into its lowest position. In contrast, on the left hand side of FIG. 1, the shelf 50 of the wagon 34 is coupled to the lifting platform 30. The shelf and the sleeves are raised together with the lifting platform so that the operating personnel can now change the sleeves. When fitting the mandrels of the shelf, one mandrel is left free, on the one hand, for the engraved roller sleeves and, on the other hand, for the printing sleeves so that the sleeves can be changed in succession in one operation by the operating personnel. The number of mandrels, depicted in the design according to FIG. 1, is reproduced here only as an illustration. Of course, an arbitrary number of mandrels can be disposed on the shelf.

The right hand side of FIG. 2 shows a wagon 34 with the shelf 50 moved to the top, whereby a printing sleeve 56 is being removed from the shelf. On the left hand side a wagon 34 is depicted in the lowered and uncoupled position.

1. Changing station for sleeves of printing machines with a lifting platform, disposed on the side of the printing machine, and with a wagon, in which a vertically adjustable shelf with carrying mandrels for receiving sleeves is received, whereby the shelf can be coupled to the lifting platform for joint lifting and lowering.

2. Changing station for sleeves, as claimed in claim 1, characterized in that the lifting platform exhibits a front and two side protective gates, whereby at least one of the side protective gates is designed as a folding door.

3. Changing station for sleeves, as claimed in claim 1 or 2, characterized in that the lifting platform can be raised and lowered by means of a motor-driven scissor lift.

4. Changing station for sleeves, as claimed in any one of the claims 1 to 3, characterized in that the wagon is enclosed on three sides and open in the direction of one side, whereby the shelf receiving the carrying mandrels is aligned in such a manner in the wagon that the carrying mandrels can be attended from the open side of the wagon.

5. Changing station for sleeves, as claimed in any one of the claims 1 to 4, characterized in that the wagon is open at the top; and the vertically adjustable shelf is mounted in the wagon so as to be vertically adjustable by means of slide bearings.

6. Changing station, as claimed in any one of the claims 1 to 5, characterized in that the shelf is made of a structural steel beam, whereby this structural steel beam can be coupled to the front protective gate of the lifting platform by means of a coupling mechanism.

7. Changing station, as claimed in claim 6, characterized in that the coupling mechanism comprises journals, which engage with an opposing journal receptacle.

8. Changing station for sleeves, as claimed in claim 7, characterized in that on the front protective gate of the lifting platform there are additionally support brackets, against which at least one support of the shelf is braced in the coupled state.

9. Changing station, as claimed in any one of the claims 1 to 8, characterized in that the wagon is mounted on rollers, which can be locked by means of locking brakes.
